(19) United States
(12) Patent Application Publication
(10) Pub. No.: US 2026/0075593 A1
(43) Pub. Date: Mar. 12, 2026

(54) TERRESTRIAL NETWORK DOWNLINK AND UPLINK CO-CHANNEL INTERFERENCE MANAGEMENT ON NON-TERRESTRIAL NETWORK UPLINK

(71) Applicant: DISH Wireless L.L.C., Littleton, CO (US)

(72) Inventors: Jingyi Zhou, Belle Mead, NJ (US); Sourabh Gupta, Ashburn, VA (US); Mehdi Alasti, Arlington, VA (US)

(21) Appl. No.: 18/830,933

(22) Filed: Sep. 11, 2024

(51) Int. Cl. H04W 72/0446; H04W 72/0457; H04W 72/12; H04W 84/06

(52) U.S. Cl. CPC H04W 72/0446; H04W 72/0457; H04W 72/12; H04W 84/06

(57) ABSTRACT

Approaches are described herein for mitigating terrestrial network (TN) uplink and downlink co-channel interference on non-terrestrial network (NTN) uplinks using scheduled orthogonalization. The scheduled orthogonalization can include temporal, spectral, and/or code-based orthogonalization. For example, there is a terrestrial radio access network (T-RAN) and a non-terrestrial RAN (NT-RAN) having some amount of coordination. For each TN cell in each of several temporal frames, a determination is made as to whether there is a potential co-channel interference condition between the TN cell and an NTN beam for that temporal frame. If so, a first orthogonalization scheme is scheduled for application to the TN communications for the cell in the temporal frame, and a second orthogonalization scheme is scheduled for application to the NTN communications for the beam in the temporal frame, such that the first and second orthogonalization schema are orthogonal in at least one of time, frequency, or code.

### BACKGROUND OF THE INVENTION

Wireless connectivity continues to evolve to meet demands for ubiquity, convenience, reliability, speed, responsiveness, and the like. For example, each new generation of cellular communication standards, such as the move from 4G/LTE (fourth generation long-term evolution) networks to 5G (fifth generation) networks, has provided a huge leap in capabilities along with new and increasing demands on the infrastructures that enable those networks to operate. For example, 5G supports innovations, such as millimeter-wave frequencies, massive MIMO (Multiple Input Multiple Output), and network slicing, which enhance connectivity for unprecedented numbers of devices and data-intensive applications.

More recently, innovations in 5G networking (and its successors) have expanded from terrestrial-based communication infrastructures to so-called non-terrestrial network (NTN) infrastructures. NTN infrastructures leverage satellites and high-altitude platforms to extend 5G coverage and capabilities, such as to serve remote and otherwise underserved areas. Effective deployment of NTN solutions can help support connectivity and applications for rural users, emergency responders, global Internet-of-Things (IoT) deployments, etc.

However, non-terrestrial communications carry complexities and design concerns that are not present in terrestrial-based communications, which can add significant technical hurdles to NTN deployments. For example, effective ground-to-satellite communications involves accounting for orbital dynamics, handovers and/or other transitions between satellites, path loss, propagation delay, atmospheric conditions, inter-satellite and/or inter-beam interference, spectrum and regulatory considerations, and other considerations. Additionally, interference concerns can arise in regions where non-terrestrial beams and terrestrial cells are communicating over the same or similar portions of spectrum. New approaches continue to be developed to find technical solutions for overcoming, or at least mitigating, these and other technical hurdles.

### BRIEF SUMMARY OF THE INVENTION

Systems and methods are described herein for mitigating terrestrial network (TN) uplink and downlink co-channel interference on non-terrestrial network (NTN) uplinks using scheduled orthogonalization. The scheduled orthogonalization can include temporal, spectral, and/or code-based orthogonalization. For example, there is a terrestrial radio access network (T-RAN) and a non-terrestrial RAN (NT-RAN) having some amount of coordination. For each TN cell in each of several temporal frames, a determination is made as to whether there is a potential co-channel interference condition between the TN cell and an NTN beam for that temporal frame. If so, a first orthogonalization scheme is scheduled for application to the TN communications for the cell in the temporal frame, and a second orthogonalization scheme is scheduled for application to the NTN communications for the beam in the temporal frame, such that the first and second orthogonalization schema are orthogonal in at least one of time, frequency, or code.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B show a highly simplified communication environment.

FIG. 2 shows an example of a time-based orthogonalization scheme for scheduled application to terrestrial network (TN) and non-terrestrial network (NTN) communications to address co-channel interference conditions, according to some embodiments described herein.

FIG. 3 shows an example of a frequency-based orthogonalization scheme for scheduled application to terrestrial network (TN) and non-terrestrial network (NTN) communications to address co-channel interference conditions, according to some embodiments described herein.

FIG. 4 shows an example of another frequency-based orthogonalization scheme for scheduled application to terrestrial network (TN) and non-terrestrial network (NTN) communications to address co-channel interference conditions, according to some embodiments described herein.

FIG. 5 shows an example of a code-based orthogonalization scheme for scheduled application to terrestrial network (TN) and non-terrestrial network (NTN) communications to address co-channel interference conditions, according to some embodiments described herein.

FIG. 6 shows an example of a network environment having both non-terrestrial network (NTN) and terrestrial network (TN) portions.

FIG. 7 shows a partial communication environment that includes an illustrative embodiment of a TN-NTN Interference Manager, according to embodiments described herein.

FIG. 8 provides a schematic illustration of an embodiment of a computational system that can implement various system components and/or perform various steps of methods provided by various embodiments.

FIG. 9 shows a flow diagram of an illustrative method for terrestrial network (TN) uplink and downlink co-channel interference mitigation on non-terrestrial network (NTN) uplinks, according to embodiments described herein.

FIG. 10 shows a flow diagram of another illustrative method for TN uplink and downlink co-channel interference mitigation on NTN uplinks, according to embodiments described herein.

### DETAILED DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

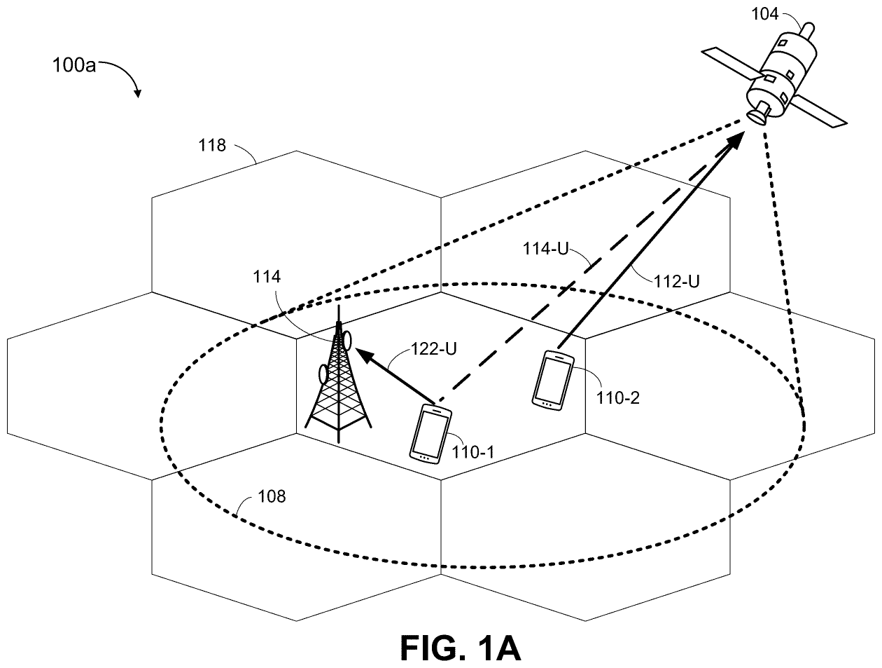

For the sake of providing context for embodiments described herein, FIGS. 1A and 1B show a highly simplified communication environment 100. The communication environment 100 includes both a non-terrestrial network (NTN) portion (e.g., including satellite network infrastructure) and a terrestrial network (TN) portion (e.g., including cellular network infrastructure). For embodiments described herein, the environment 100 is assumed to have at least some geographical regions and/or timeframes in which there is an overlap between TN communication coverage (e.g., cellular coverage) and NTN communication coverage (e.g., satellite beam coverage). The NTN portions of the network can be an NTN extension of a TN infrastructure. For example, fifth generation (5G) cellular standards support NTN extensions and define ways in which the NTN portion can be modified to implement 5G new radio (NR) protocols and other 5G concepts. In some implementations, the NTN and TN portions of the network are fully integrated. In other implementations, there is only enough integration to facilitate features described herein. For example, embodiments described herein schedule orthogonalization of TN uplink (UL) communications, TN downlink (DL) communications, and/or NTN UL communications based on a knowledge of potential co-channel overlap. Implementing such features involves enough integration so that the TN is aware of locations and frequency bands of NTN beams over time, and/or the NTN is aware of locations and frequency bands of TN cells over time.

The illustrated environment 100 includes cells 118 produced by cell towers 114 and defining respective cell coverage areas on the surface of the Earth. Although only a single cell tower 114 is shown in the simplified illustration, a real-world deployment will have many cell towers 114. A network of cell towers 114 is strategically positioned to provide coverage across a defined geographic area, and each cell tower 114 can transmit and receive signals to and from user terminals 110 (e.g., mobile devices) within its coverage area (i.e., its cell 118). Notably, reference to “cell towers” is intended to include any located on which terrestrial antennas are mounted. For example, terrestrial antennas can also be installed on buildings, etc. Depending on many factors (e.g., terrain, frequency band, physical obstacles, etc.), the effective communication range of a single cell tower 114 can range from only a few hundred meters to several tens of kilometers. Each cell tower 114 can typically service multiple cells 118, such as by including multiple cellular antennas, using sectorization, etc. A typical urban deployment may have a much higher density of cells 118, such as spaced 0.1 to 1.2 miles apart. Each urban cell tower 114 may serve smaller cells 118, known as microcells or picocells. A typical rural deployment may have a lower density of cells 118, such as spaced 3 to 18 miles apart, or farther. Each rural cell tower 114 typically cover larger cells 118, known as macrocells.

Although there is estimated to be over one million cell towers 114 worldwide, the cell towers 114 alone cannot provide global coverage. As noted above, recent standards (e.g., 5G) have begun to facilitate NTN extensions to those cellular networks. The illustrated environment 100 includes beams 108 produced by satellites 104. The beams 108 define respective beam coverage areas on the surface of the Earth. Although only a single satellite 104 and a single beam 108 are shown in the simplified illustration, a real-world deployment can have many satellites 104 and/or many beams 108. In some cases (and/or at some times), beams 108 and cells 118 cover different geographic areas; in other cases (and/or at other times), beams 108 and cells 118 have overlapping coverage areas. For example, the illustrated environment 100 shows a beam 108 having overlapping coverage with several cells 118. The illustrated number and sizes of the cells 118 relative to the beam 108 is not intended to be representative of an actual deployment. Depending on factors, such as population density, beam size, cell size, cell tower density, topology, etc., tens or hundreds of cells 118 can fit within a single beam coverage area.

In some implementations, the satellites 104 are geosynchronous orbit (GEO) satellites 104. For example, a typical GEO satellite can orbit the Earth at an altitude of approximately 35,786 kilometers (22,236 miles) above the equator, so that the satellite's orbit matches the Earth's rotation, and the satellite effectively remains stationary relative to a fixed point on the Earth's surface. Each GEO satellite can typically produce large numbers (e.g., dozens, hundreds, etc.) of spot beams 108 to cover extensive geographic areas and support high-capacity data transmissions.

In other implementations, the satellites 104 are non-geosynchronous orbit (NGSO) satellites 104, such as low-Earth orbit (LEO) or medium-Earth orbit (MEO) satellites 104. LEO satellites typically orbit the Earth at altitudes ranging from 180 kilometers (112 miles) to 2,000 kilometers (1,242 miles), thereby enabling lower-latency communication services. Each LEO satellite typically produces a smaller number of beams 108, such as one beam 108, four beams 108, or even tens of beams 108. Often, such satellites 104 are deployed in constellations, sometimes including tens, hundreds, or thousands of satellites 104 to provide global coverage as they move rapidly in one or more orbits, orbital planes, etc. MEO satellites typically orbit at altitudes between 2,000 kilometers (1,242 miles) and 35,786 kilometers (22,236 miles). They are often deployed in smaller constellations, and each MEO satellite often produces a higher number of larger beams 108 than LEO satellites, so that the constellation can cover larger regions with fewer satellites 104.

Although embodiments of NTN portions of the network are described herein with reference to satellite communications, NTN portions can also be implemented using high-altitude platform systems (HAPS), or the like. HAPS are aerial platforms, such as balloons, airships, or unmanned aerial vehicles (UAVs), that operate in the stratosphere at altitudes typically between 17 to 22 kilometers (approximately 10.5 to 13.7 miles) above the Earth's surface. In the NTN context, HAPS can be strategically positioned to provide telecommunications and broadband services over wide geographic areas. For example, by operating above weather disturbances and commercial air traffic, HAPS can deliver stable and reliable connectivity. Some NTN deployments can additionally or alternatively use low-altitude platform systems (LAPS), and/or other non-terrestrial platforms.

As noted above, beams 108 and cells 118 can have overlapping coverage areas. The NTN portion of the network (e.g., the satellite portion) communicates using NTN frequency bands and the TN portion of the network (e.g., the cellular portion) communicates using TN frequency bands. In some deployments, NTN frequency bands can overlap with TN frequency bands. For example, situations arise in which the same spectrum is allocated to a TN communications service provider and to an NTN communications service provider, where both providers serve overlapping geographic regions (or a single provider with both TN and NTN service offerings). The overlaps can cause co-channel interference between the NTN and TN communications. Such interference can degrade the quality of service, reduce data throughput, cause communication disruptions for users on one or both networks, and/or cause other undesirable degradations. A conventional remediation approach for such cases is typically for the TN and NTN providers to agree to a space-based sharing scheme. For example, the NTN communications service provider agrees not to broadcast in that spectrum in overlapping regions.

Embodiments described herein are particularly focused on two co-channel interference scenarios. FIG. 1A illustrated a first co-channel interference scenario in which an uplink (UL) portion of TN communications manifests co-channel interference with an uplink (UL) portion of NTN communications. For example, FIG. 1A shows a TN UL to the cell tower 114 from a first UT 110-1 (TN UL 122-U) and a first NTN UL from a second UT 110-2 to the satellite 104 (NTN UL 112-U). Overlap in transmission frequencies for TN UL 122-U and NTN UL 112-U can potentially manifest an interfering second NTN UL 114-U from UT 110-1 to the satellite 104 (also essentially TN UL 122-U, shown as a dashed line). This can impact communications on the network in several ways. For example, such an interference scenario can reduce data throughput for both TN and NTN users, increase latency due to delays in signal processing and retransmissions, degrade signal quality, reduce network reliability (e.g., including increasing the potential for dropped connections, service interruptions, etc.), increase power consumption, etc.

FIG. 1B illustrates a second co-channel interference scenario in which a DL portion of TN communications manifests co-channel interference with NTN UL communications. For example, FIG. 1B shows a TN DL from the cell tower 114 to the first UT 110-1 (TN DL 122-D) and a first NTN UL from the second UT 110-2 to the satellite 104 (NTN UL 112-U). Overlap in transmission frequencies for TN DL 122-D and NTN UL 112-U can potentially manifest an interfering second NTN UL 124-U from UT 110-1 to the satellite 104 (also essentially TN UL 122-U, shown as a dashed line). This can impact communications on the network in several ways. For example, such an interference scenario can reduce data throughput for TN users, increase latency, degrade signal quality, reduce network reliability, increase power consumption, etc.

In some network deployments, the TN portions of the network is configured for time-division duplex (TDD) communications. In TDD, the same cell tower 114 may use the same portion of spectrum for UL communications in some temporal frames and for DL communications in other temporal frames. As such, a particular cell can experience co-channel interference of the type illustrated in FIG. 1A in some temporal frames and of the type illustrated in FIG. 1B in other temporal frames.

Embodiments described herein mitigate TN UL and DL co-channel interference on the NTN UL using scheduled orthogonalization. As described herein, the scheduled orthogonalization can include time-based orthogonalization, frequency-based orthogonalization, and/or code-based orthogonalization. For example, there is a terrestrial radio access network (T-RAN) and a non-terrestrial RAN (NT-RAN) having some amount of coordination. For each TN cell in each of several temporal frames, a determination is made as to whether there is a potential co-channel interference condition between the TN cell and an NTN beam for that temporal frame. If so, a first orthogonalization scheme is scheduled for application to the TN communications for the cell in the temporal frame, and a second orthogonalization scheme is scheduled for application to the NTN communications for the beam in the temporal frame, such that the first and second orthogonalization schema are orthogonal in at least one of time, frequency, or code.

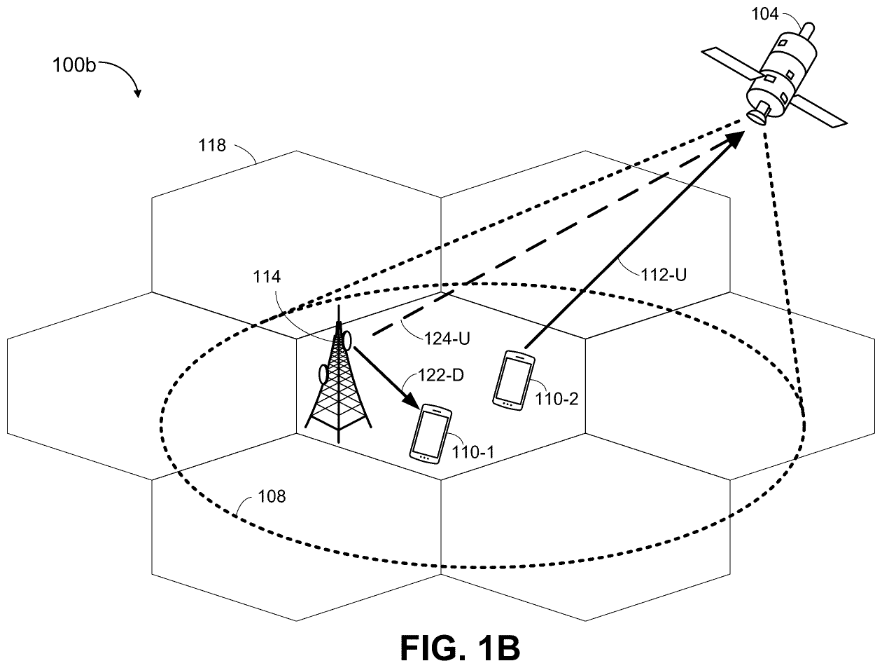

FIG. 2 shows an example of a time-based orthogonalization scheme 200 for scheduled application to terrestrial network (TN) and non-terrestrial network (NTN) communications to address co-channel interference conditions, according to some embodiments described herein. As illustrated, TN communications and NTN communications can be broken into time slots corresponding to temporal frames. Typically, each temporal frame includes many time slots.

FIG. 2 assumes that a determination has been made that there is a potential co-channel interference condition between a particular TN cell's UL communications and a particular NTN beam's UL communications for some particular temporal frame or sequential set of temporal frames. A first orthogonalization scheme is scheduled for application in the temporal frame(s) to the TN UL communications for the cell in the temporal frame, which involves scheduling the TN UL communications only for a first subset of time slots (TN UL slots 210) in the temporal frame. A second orthogonalization scheme is scheduled for application to the NTN communications for the beam in the temporal frame, which involves scheduling the NTN UL communications only for a second subset of time slots (NTN UL slots 220) in the temporal frame. The first and second subsets of time slots are disjoint (i.e., non-overlapping), such that the TN and NTN UL communications are temporally orthogonal.

As illustrated, the scheduling can involve assigning a padding time 225 to either side of the TN UL slots 210 and/or the NTN UL slots 220. The padding time 225 helps to ensure that there is no temporal overlap between the TN UL slots 210 and the NTN UL slots 220. As described herein, embodiments operate in context of a T-RAN and an NT-RAN that have some amount of coordination. In cases of tight coordination (e.g., where the T-RAN and the NT-RAN share a clock or otherwise have direct clock synchronization), the padding time 225 can be very small, or even zero-time (e.g., corresponding with a small number of, or even zero, time slots). In cases of loose coordination (e.g., where the T-RAN and the NT-RAN are deployed by separate providers, do not share a clock, etc.), the padding time 225 can be as large as needed to ensure temporal orthogonality (e.g., corresponding with a larger number of TN and/or NTN time slots). Although FIG. 2 specifically shows a case of co-channel interference between TN UL and NTN UL communications, the same scheduled orthogonalization approach can also be applied to cases of co-channel interference between TN DL and NTN UL communications.

A limitation of such a scheme is that, in the cells and temporal frames in which it is applied, the affected TN and NTN communications experience temporal inefficiency. In particular, each can only communicate for its respective portion of the time slots. In cases with padding times 225 (especially when there is less coordination and a correspondingly larger padding time 225), the temporal inefficiency is increased.

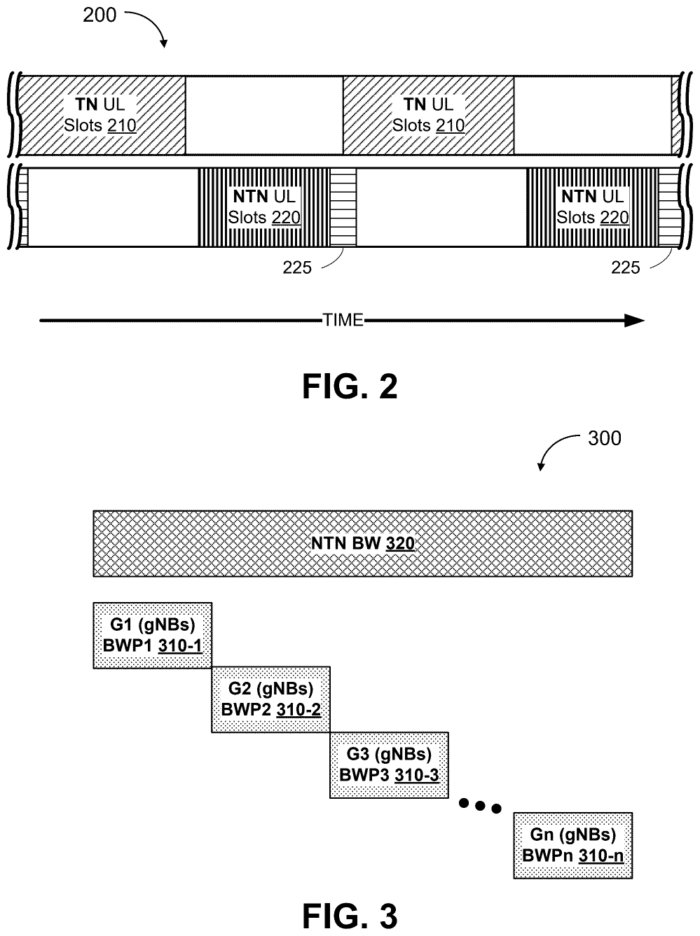

FIG. 3 shows an example of a frequency-based orthogonalization scheme 300 for scheduled application to terrestrial network (TN) and non-terrestrial network (NTN) communications to address co-channel interference conditions, according to some embodiments described herein. As illustrated, cells (e.g., cell towers 114) can be grouped into N cell groups, where N is an integer greater than 1. The spectrum of concern (i.e., the spectrum assigned both to TN and NTN communications) can also be broken into N bandwidth parts (BWPs) 310. Each BWP corresponds to a particular disjoint sub-band (e.g., 1/N) of the spectrum. For the sake of simplicity, it is assumed that the entire spectrum of concern is allocated for NTN use (shown as NTN BW 320). For example, the spectrum of interest can be the spectrum assigned to a potentially interfering beam being used in a temporal frame for NTN UL communications, such that the NTN BW 320 is the NTN UL spectrum. As one example, an NTN BW 320 of 20 MHz is partitioned into 4 BWPs of 5 MHz each.

FIG. 3 assumes that a determination has been made that there is a potential co-channel interference condition between one or more TN cell's communications (e.g., UL communications) and a particular NTN beam's UL communications for some particular temporal frame or sequential set of temporal frames. A first orthogonalization scheme is scheduled for application in the temporal frame(s) to the TN UL communications for the cell in the temporal frame. This can involves assigning each cell group to a corresponding BWP 310. For example, a first cell group (‘G1’) is assigned to BWP 310-1, a second cell group (‘G2’) is assigned to BWP 310-2, and an nth cell group (‘Gn’) is assigned to BWP 310-n. A second orthogonalization scheme is scheduled for application to the NTN communications for the beam in the temporal frame, which involves scheduling the NTN UL communications for the NTN BW 320. This schema can be applied in cases of co-channel interference between TN UL and NTN UL communications and/or in cases of co-channel interference between TN DL and NTN UL communications. Further, although FIG. 3 illustrated partitioning of only the TN spectrum, the partitioning can be applied additionally or alternatively to the NTN spectrum. For example, NTN uplinks can be assigned to groups, each associated with one or some number of BWPs, and those NTN uplinks are restricted to use only their allocated BWP in interfering conditions.

The illustrated scheme produces partial spectral orthogonality. In this scheme, TN communications involving a cell assigned to any particular one of the N cell groups will only potentially have co-channel interference with 1/N of the NTN BW 320. As such, the communications are spectrally orthogonal in the other (N−1)/N of the NTN BW 320. A limitation of such a scheme is that, in the cells and temporal frames in which it is applied, the affected TN and/or NTN communications experience spectral inefficiency. In particular, each cell tower 114 (or cell, gNB, etc.) can only use the portion of the spectrum assigned to its cell group. Further, there is a tradeoff between spectral orthogonality and spectral inefficiency. For example, partitioning into a larger number of BPWs can add spectral orthogonality (i.e., for a higher N, 1/N is a smaller portion of the spectrum of concern), while also increasing the spectral inefficiency for the cells assigned to each cell group.

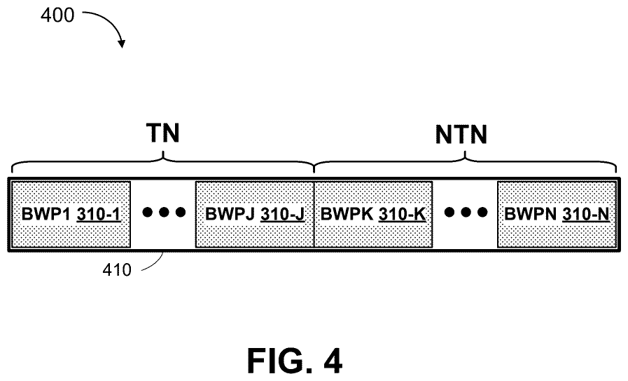

FIG. 4 shows an example of another frequency-based orthogonalization scheme 400 for scheduled application to terrestrial network (TN) and non-terrestrial network (NTN) communications to address co-channel interference conditions, according to some embodiments described herein. As illustrated, a spectrum of interest 410 is segregated into N BWPs 310 (N is an integer greater than 2). FIG. 4 assumes that a determination has been made that there is a potential co-channel interference condition between a particular TN cell's communications (e.g., UL communications) and a particular NTN beam's UL communications for some particular temporal frame or sequential set of temporal frames.

A first orthogonalization scheme is scheduled for application in the temporal frame(s) to the TN UL communications for the cell in the temporal frame, which involves assigning the cell to a first subset of the BWPs 310. For example, the TN communications for the cell are scheduled to use BWPs 310-1-310-J during the temporal frame. A second orthogonalization scheme is scheduled for application to the NTN communications for the beam in the temporal frame, which involves assigning the beam to a second subset of the BWPs 310. For example, the NTN communications for the beam are scheduled to use BWPs 310-K-310-N during the temporal frame. The first and second subsets of BWPs 310 are disjoint (non-overlapping), so that the TN and NTN communications are spectrally orthogonal. This schema can be applied in cases of co-channel interference between TN UL and NTN UL communications and/or in cases of co-channel interference between TN DL and NTN UL communications. This scheme has a similar limitation to the scheme illustrated by FIG. 3. In the cells and temporal frames in which it is applied, the affected TN and/or NTN communications experience spectral inefficiency by being restricted to communicate over only a portion of the spectrum.

In some embodiments, any of the scheduled orthogonality approaches of FIGS. 2-4 can be extended to include selective allocation based on demand for the orthogonalized resource. For example, the approach of FIG. 2 orthogonalizes temporal resources, and the approaches of FIGS. 3 and 4 orthogonalize spectral resources. Such embodiments, having determined that there is an interference condition between a cell and a beam, can further determine a relative cell-beam demand for the orthogonalized resource. Such embodiments can selectively allocate more or less of the orthogonalized resource based on the determined demand. As one example, in FIG. 2 approaches, such selective allocation can involve determining how many time slots to allocate to each of TN and NTN communications during the temporal frame. As another example, in FIG. 4 approaches, such selective allocation can involve determining how many BWPs to allocate to each of TN and NTN communications during the temporal frame.

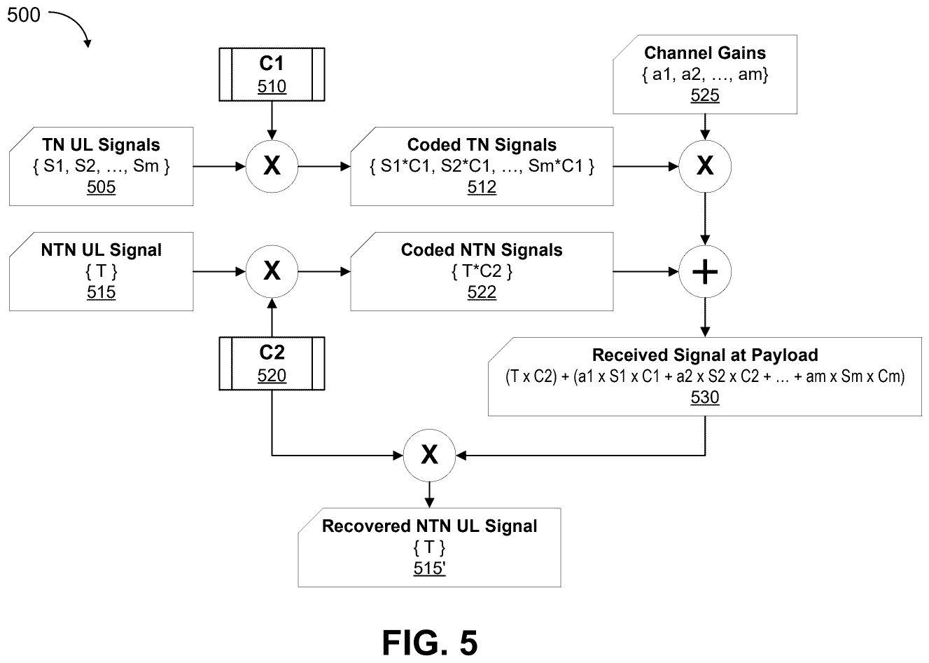

FIG. 5 shows an example of a code-based orthogonalization scheme 500 for scheduled application to terrestrial network (TN) and non-terrestrial network (NTN) communications to address co-channel interference conditions, according to some embodiments described herein. As illustrated, there is assumed to be a set of TN signals 505 (S1, S2, . . . , Sm) potentially interfering with an NTN UL signal (T) 515. For example, each TN signal 505 corresponds to communications from a particular cell tower 114, and multiple cell towers 114 can be interfering at the same time.

FIG. 5 assumes that a determination has been made that there is a potential co-channel interference condition between one or more TN cell's communications (e.g., TN UL communications) and a particular NTN beam's UL communications for some particular temporal frame or sequential set of temporal frames. A first orthogonalization scheme is scheduled for application in the temporal frame(s) to the TN UL communications for the cell in the temporal frame, which involves multiplying the TN signals 505 by a first cover code 510. The result is a set of coded TN signals 512 (S1*C1, S2*C1, . . . , Sm*C1). A second orthogonalization scheme is scheduled for application in the temporal frame(s) to the NTN UL communications for the cell in the temporal frame, which involves multiplying the TN signal 515 by a second cover code 520. The result is a coded NTN signal 522 (T*C2). The first cover code 510 and the second cover code 520 are orthogonal, such that C2*C2=C1*C1=1; and C1*C2=0.

It can be assumed that the TN channels between each of the cell towers 114 and the NTN payload have channel gains 525 (a1, a2, . . . , aM). Thus, the received signal at the NTN payload can be considered essentially as the coded TN signals 512 multiplied by their respective channel gains 525, plus the coded NTN signal 522, which can be expressed as:

$$( T * C 2 ) + [ ( a 1 * S 1 * C 1 ) + ( a 2 * S 2 * C 1 ) + … + ( am * Sm * C 1 ) ] = ( T * C 2 ) + C 1 * [ ( a 1 * S 1 ) + ( a 2 * S 2 ) + … + ( am * Sm ) ] .$$

At the NTN payload (e.g., at the satellite), the second cover code 520 can be applied to the received signal, yielding the following:

$$[ C 2 * ( T * C 2 ) ] + \{ C 2 * C 1 * [ ( a 1 * S 1 ) + ( a 2 * S 2 ) + … + ( am * Sm ) ] \} = [ ( C 2 * C 2 ) * ( T ) ] + [ ( C 2 * C 1 ) * [ ( a 1 * S 1 ) + ( a 2 * S 2 ) + … + ( am * Sm ) ] = [ ( 1 ) * ( T ) ] + [ ( 0 ) * [ ( a 1 * S 1 ) + ( a 2 * S 2 ) + … + ( am * Sm ) ] = T .$$

Thus, all the co-channel interference from the TN UL signals 505 is removed from the NTN UL signal 515, resulting in a recovered NTN UL signal 515′ that is substantially identical to the NTN UL signal 515. The same scheme can be applied to TN DL communications. Notably, this scheme provides full code-based orthogonality without the temporal or spectral inefficiencies of the approaches of FIGS. 2-4. However, this approach relies on tight coordination between the T-RAN and NT-RAN. One reason is that the cover codes applied in the TN and NTN systems must be designed for full orthogonality; they must satisfy the constraint that C2*C2=C1*C1=1; and C1*C2=0. Another reason is that, if the coded TN and NTN communications are not phase-aligned, the orthogonal coding will fail to cancel the co-channel interference. Another limitation of this approach is that the scheme relies on support in the air-interface of both the TN and NTN communications, which is not available in current (e.g., 5G) standards. Future wireless technologies (e.g., 6G) can be configured to support this use of cover codes to manage co-channel interference.

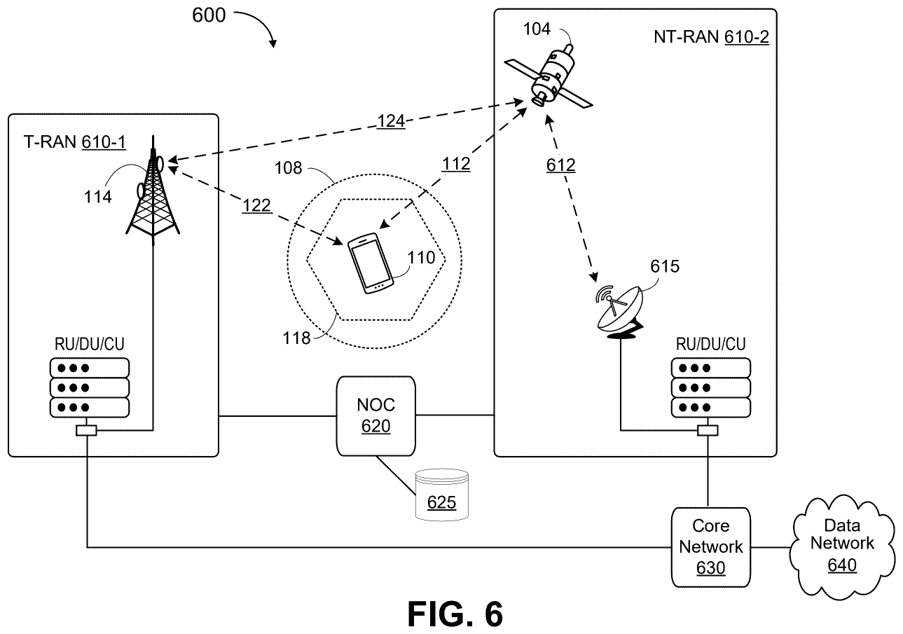

For added context, FIG. 6 shows an example of a network environment 600 having both non-terrestrial network (NTN) and terrestrial network (TN) portions. The network environment 600 can be an implementation of the network environment 100 of FIGS. 1 and 2. FIG. 6 can represent a type of network environment 600 in which the same operator provides both the TN and NTN services using a shared core network. Alternatively, FIG. 6 can represent a type of network environment 600 in which separate TN and NTN operators agree to share components of a core network. This can provide “tight” coordination between the TN and TNT portions of the network. For example, such an architecture can facilitate sharing or synchronizing of clock timing across the networks.

Embodiments described herein can operate in such an environment 600 but are not limited to such an environment 600. For example, embodiments that use code-based orthogonalization can rely on tight coordination between the TN and NTN portions of the network, such as facilitated by the architecture of FIG. 6. Embodiments that use temporal orthogonalization and/or spectral orthogonalization can be configured to operate with tighter or looser coordination between the networks. For example, as described above, the approach of FIG. 2 can add padding time to one or both the temporal orthogonalization schemes to ensure that the TN and NTN time slots do not overlap in cases of looser coordination.

As described with reference to FIG. 1, the NTN portion produces beams 108, and the TN portion produces cells 118. In some geographical locations and/or at some times, one or more beams 108 can overlap with one or more cells 118, potentially resulting in co-channel interference, including uplink and/or downlink co-channel interference. Communications with user terminals (UTs) 110 in those overlapping regions can be negatively impacted by such co-channel interference. Only a single user terminal 110 is shown located within a single cell 118 fully overlapped by a single beam 108. This is intended generally to represent any suitable number of user terminals 110 located within any suitable number of cells 118 fully or partially overlapped by any suitable number of beams 108.

As illustrated, the communication environment 600 can be considered as having two radio access networks 610: a terrestrial RAN (T-RAN) 610-1 and a non-terrestrial RAN (NT-RAN) 610-2. The T-RAN 610-1 provides wireless connectivity between UTs 110 and a core network 630. As noted above, the environment 600 of FIG. 6 shows a shared core network 630, but embodiments described herein can operate in environments having separate TN and NTN core networks. The T-RAN 610-1 can include cell towers 114 (also referred to as base stations, or gNodeBs), antennas, radio frequency (RF) transceivers, backhaul connections, and/or any other suitable components. The RF transceivers convert digital signals into RF signals and vice versa, facilitating wireless communication. Backhaul connections, such as fiber optic or microwave links, connect the cell towers 114 to the core network 630. The T-RAN 610-1 performs several roles, such as managing network resources, performing radio resource management (RRM) (e.g., handovers, load balancing, and interference mitigation), etc.

The T-RAN 610-1 can establish TN channels 122 (uplink and downlink) with UTs 110. For example, the T-RAN 610-1 can establish and perform communications over those TN channels 122 through a series of well-coordinated steps. A cell tower 114 broadcasts synchronization signals and system information blocks (SIBs) that enable the UTs 110 to detect and synchronize with the network. Once a UT 110 is connected, the cell tower 114 assigns radio resources for transmission. Data from the core network 630 arrives at the cell tower 114 via the backhaul connection for downlink transmission, or data from the UT 110 is transmitted via its antenna for uplink transmission. The RF transceivers at the cell tower modulate downlink data into RF signals and demodulate uplink RF signals into data, employing advanced beamforming techniques to direct RF signals to or from the UT, optimizing signal strength and minimizing interference. On the downlink, the UT 110 receives the downlink RF signals through its antenna, demodulates them, and processes the data for the end-user. Throughout this process, the cell tower 114 continuously monitors the link quality and adjusts transmission parameters, such as power levels and modulation schemes, to ensure robust and efficient communication.

The NT-RAN 610-2 includes satellite communication components, such as satellites 104 and ground stations 615 (e.g., gateways, NTN UTs (such as very small-aperture terminals, VSATs), etc.). In environments like the communication environment 600, the NT-RAN 610 is configured to extend the TN (e.g., 5G) coverage, such as to remote, rural, and underserved areas where terrestrial infrastructure is impractical or otherwise unavailable. The satellites 104 themselves include and facilitate communication features, such as transponders, antennas, beamforming capabilities, inter-satellite links, etc. Ground stations 615 effectively interface between the NT-RAN 610-2 and the terrestrial core network 630. For example, the ground stations 615 can handle data routing, frequency conversion, signal amplification, and/or other features.

The NT-RAN 610-2 can establish NTN channels 112 (uplink and downlink) with UTs 110. In the NT-RAN 610-2, both downlink and uplink communications with UTs 110 via these NTN channels 112 can involve sophisticated processes to leverage both NTN and TN (e.g., satellite and cellular) technologies. For example, communications begin with data transmission from the core network to a ground station 615, which then uplinks the data to a satellite 104 via a feeder link 612. The satellite 104 receives the uplinked signals via its onboard antennas, and its transponders process and amplify the signals. The satellite 104 directs the downlink RF signals (e.g., using beamforming and/or other techniques) towards a UT's 110 location, optimizing signal coverage and strength. The UT 110, equipped with a satellite-compatible antenna and receiver, captures the downlinked RF signals, demodulates them, and processes the data for an end-user. Similarly, UTs 110 can initiate uplink communications by transmitting data to the satellite 104 via NTN channels 112 using a satellite-compatible antenna and transmitter. The satellite 104 processes and amplifies these signals before downlinking them to the ground station 615 via the feeder link 612, which forwards the data to the core network 630. Throughout the communication process, the satellite 104 continuously adjusts its beam patterns and transmission parameters to maintain optimal link quality. In some implementations, inter-satellite links (ISLs) can be used to relay data directly between satellites 104.

As illustrated, both the T-RAN 610-1 and the NT-RAN 610-2 are in communication with a network operations center (NOC) 620. As noted above, other embodiments can operate in context of environments where the TN and NTN portions are loosely coordinating and do not both communicate with a same NOC 620. The NOC 620 generally serves as the centralized hub for overseeing the performance, health, and security of the entire network infrastructure (i.e., both the NTN and the TN portions of the network environment 600). For example, the NOC 620 includes network management systems (NMSs) to provide real-time dashboards, alerts, and control mechanisms for both the T-RAN 610-1 and the NT-RAN 610-2. The NOC 620 can use telemetry and protocols (e.g., Simple Network Management Protocol (SNMP)) to collect performance data (e.g., signal quality, traffic load, fault occurrences, etc.) from cell towers 114 in the T-RAN 610-1 and from satellites 104 and ground stations 615 in the NT-RAN 610-2. The NOC 620 can analyze the data to support proactive fault detection, performance optimization, configuration management, security management, and or other features.

As noted above, both the T-RAN 610-1 and the NT-RAN 610-2 are in communication with a core network 630. The core network 630 can be implemented as a software-defined infrastructure to manage and orchestrate the entire 5G ecosystem, including both the T-RAN 610-1 and the NT-RAN 610-2. The core network 630 can perform several roles, such as handling session management and mobility management, managing authentication and authorization processes, implementing network slicing, facilitating data routing and forwarding, overseeing policy control and charging, etc. Although certain terminology used herein is typically associated with 5G ecosystems, embodiments can be implemented in any suitable current or future wireless infrastructure, such as 6G. For example, in the 5G context, the core network 330 can be referred to as the 5G core (5GC), but embodiments can be implemented with future 6G core networks 330, as well.

The core network 620 also acts as a central hub to connect the T-RAN 610-1 and the NT-RAN 610-2 to one or more external data networks (illustrated generally as data network 640). The core network 630 and the data network 640 are connected via high-capacity, low-latency links that facilitate rapid and seamless data exchange. The data network 640 can include any suitable networks, such as the Internet, private enterprise networks, cloud services, content delivery networks (CDNs), etc. The data network 640 can also provide several services, such as web hosting, online applications, streaming services, cloud computing platforms, IoT ecosystems, enterprise VPNs, etc.

The illustrated architecture is intended generally to represent possible coordination and/or integration between NTN and TN infrastructures. As noted above, the coordination can be looser or tighter. In some cases, one of the T-RAN 610-1 or the NT-RAN 610-2 acts as the “master” and the other acts as a slave for purposes of scheduled orthogonality described herein. In some cases, the NOC 620 acts as the master, and the T-RAN 610-1 and the NT-RAN 610-2 are both slaves for purposes of scheduled orthogonality described herein. In some cases, a different central management entity (e.g., in the core network 630 and/or in communication with the core network 630) acts as the master, and the T-RAN 610-1 and the NT-RAN 610-2 are both slaves for purposes of scheduled orthogonality described herein.

Components can be located in the network and configured for different types of coordination and/or integration. For example, both the T-RAN 610-1 and the NT-RAN 610-2 are generally illustrated as including “RU/CU/DU” components, corresponding to radio unit (RU), distributed unit (DU), and central unit (CU) functions. Each RU is responsible for transmission and reception of radiofrequency signals and interfaces directly with antennas to convert between analog and digital signal spaces. In some disaggregated models, the RU is also responsible for lower physical (PHY) layer functions. Each DU is responsible for real-time, lower-layer baseband processing, such as higher physical layer (Layer 1) processing (e.g., error correction, modulation/demodulation, encryption/decryption, etc.), and some media access control (MAC) layer (in Layer 2). In some disaggregated models, the DU is also responsible for radio link control (RLC) functions. Each CU is responsible for higher-layer functions, packet data convergence protocol (PDCP), and radio resource control (RRC) layers. The CU can also be responsible for service data adaptation protocol (SDAP) functions, such as mapping quality of service (QoS) flows to data radio bearers (DRBs).

In some implementations, the T-RAN 610-1 and/or the NT-RAN 610-2 are architected according to open radio access network (O-RAN) principles and protocols. O-RAN is an architecture that seeks to standardize interfaces between RAN components to allow network operators to mix and match products from different vendors. O-RAN deployments tend to leverage disaggregation, artificial intelligence (AI), machine learning (ML), and/or other technologies for network optimization. For example, embodiments can implement the RU, DU, and CU functions as virtualized network functions (VNFs) with standardized network interfaces. Other embodiments can implement the RU, DU, and CU functions as containerized network functions (CNFs). Integration of O-RAN principles into such deployments can increase flexibility, scalability, and efficiency of the network architecture.

For the sake of simplicity, the illustrated environment 600 shows the RU/DU/CU components located together and in a particular RAN location. In particular, the in the RU/DU/CU components of the T-RAN 610-1 are shown between the cell towers 114 and the core network 630, and the RU/DU/CU components of the NT-RAN 610-2 are shown between in the ground stations 615 and the core network 630. However, different architectures can locate the RU, DU, and CU components in different ways. In some implementations, the RUs in the T-RAN 610-1 can be deployed at the cell towers 114 (or other base station sites) to handle transmission and reception between the cell towers 114 and the UTs 110, and the RUs in the NT-RAN 610-2 can be deployed as part of the satellite 104 payloads to handle transmission and reception between the satellites 104 and the UTs 110. The DUs in the T-RAN 610-1 can be deployed within a cell tower's 114 physical site or in a more central location, such as in a nearby facility, and the DUs in the NT-RAN 610-2 can similarly be deployed on the satellite 104 or in a more central location, such as in or near a ground station 615. In one embodiment, the CUs in both the T-RAN 610-1 and the NT-RAN 610-2 are deployed in centralized ground-based data centers (e.g., in the NOC 620) to leverage computational resources and facilitate efficient network management. In some implementations that have regenerative satellites 104, certain of the RAN functions can be implemented in the satellites 104 (i.e., on the satellite payload). In one such implementation, the RU, DU, and CU functions are all be implemented in the satellites 104. In another such implementation, only the RU functions are implemented in the satellites 104, and the DU and CU functions are implemented in the NT-RAN 610-2. In another such implementation, the RU and DU functions are implemented in the satellites 104, and the CU functions are implemented in the NT-RAN 610-2. Other implementations can operate with other architectures. For example, the NT-RAN 310-2 can be implemented completely on the ground between the core network 330 and the ground station 315, or the NT-RAN 310-2 can be implemented partly on the ground and partly on the satellite. In one implementation, the NT-RAN 310-2 is implemented completely onboard the satellite 104, and the UPF (user plane function of the core network 330) is also implemented onboard the satellite 104.

As noted above, embodiments are considered with conditions in which there is overlap between NTN beam 108 coverage and TN cell 118 coverage. In some NTN deployments that use GEO satellites 104, beam 108 coverage areas may be relatively fixed, so that the overlap areas are substantially constant over time. However, other categories NTN deployments result in changing overlap areas over time. One category is NTN deployments having satellites 104 that employ beam hopping, or other dynamic beam pointing. For example, even for GEO satellites, determining which cells 118 are being overlapped by which beams 108 at any moment is dependent on the present temporal location relative to the beam-hopping schedule.

Another category is NTN deployments using NGSO satellites 104. For both LEO and MEO satellites 104, their non-geosynchronous orbits result in constant movement of their respective beam 108 coverage areas relative to the surface of the Earth. The precise locations of each satellite 104 at any time is provided by ephemeris data. The ephemeris data includes information on the satellite's 104 orbital elements, such as its semi-major axis, eccentricity, inclination, right ascension of the ascending node, argument of perigee, mean anomaly, and/or other parameters. Additionally, ephemeris data can include information on the satellite's 104 velocity, attitude, and other relevant parameters for accurate positioning. The ephemeris data can be defined and stored in formats standardized by organizations such as the International Global Navigation Satellite System (GNSS) Service (IGS).

To derive the future location of a particular beam 108 of a satellite 104, the ephemeris data can be used in conjunction with algorithms that calculate the satellite's 104 trajectory over time. The satellite's 104 future position and orientation can be predicted by inputting current ephemeris data into such algorithms. The beams 108 of a satellite 104 are directed based on its position and attitude. Thus, the predicted future position and orientation of the satellite 104 can be used to precisely calculate where each beam will be directed at any given future time.

Embodiments include a database 625 to store present ephemeris data, beam 108 data, and cell 118 data. Some implementations can store additional suitable data to support features described herein. The illustrated environment 600 shows a single database 625 in or coupled with the NOC 620. Other implementations can include any suitable number of databases 625 in any suitable location(s). For example, the database(s) 625 can be implemented in a remote server or the cloud (e.g., accessible via a data network 640 via the core network 630), in the core network 630, in one or more ground stations 615, etc.

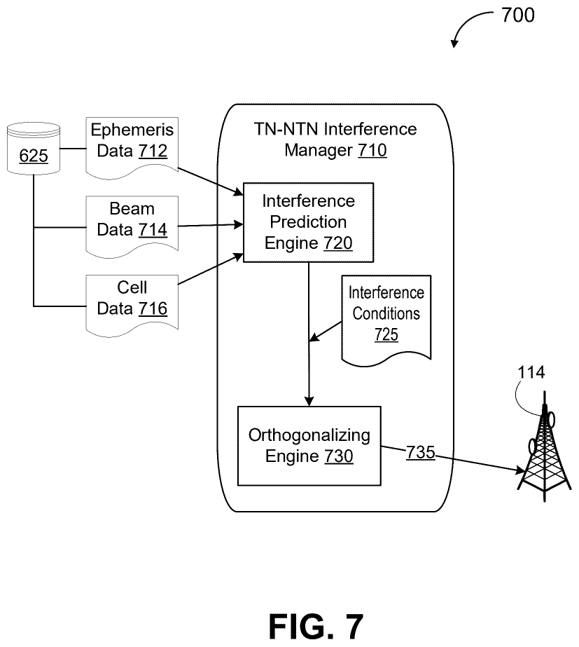

Though not explicitly shown, the environment 600 includes a TN-NTN interference manager. FIG. 7 shows a partial communication environment 700 that includes an illustrative embodiment of a TN-NTN Interference Manager 710, according to embodiments described herein. As illustrated, the TN-NTN Interference Manager 710 includes an interference prediction engine 720 and an orthogonalizing engine 730. The interference prediction engine 720 is in communication with the database(s) 625 described with reference to FIG. 6. As described there, the database(s) 625 maintain ephemeris data 712 and beam data 714 for the NTN portion of the overall communication environment and cell data 716 for the TN portion of the overall communication environment.

The interference prediction engine 720 is configured to predict, at any particular time (temporal frame), which cells 118 will be overlapping with which beams 108 at that time based on the ephemeris data 712, beam data 714, and cell data 716. As described above, the ephemeris data 712 is used to predict a location and orientation (attitude) of a satellite 104 (not shown) at the particular time based on the satellite's trajectory, orbital dynamics, etc. and predefined algorithms.

The predicted location and orientation of the satellite 104 are used to determine the coverage area of its beam 108 (or coverage areas of its beam 108, if the satellite 104 concurrently projects multiple beams 108 at the particular time). In some implementations, the beam coverage areas are computed (predicted) only from predicted location and orientation of the satellite 104 and stored information about satellite 104 characteristics (e.g., the orientations of its antennas relative to its orientation, its altitude, the sizes of its spot beams, etc.). In other implementations, the beam data 714 includes some or all of the salient data for translating the predicted location and orientation of satellite(s) 104 into beam coverage areas. The beam data 714 also associates each beam 108 with a frequency band over which the beam 108 is communicating.

The cell data 716 associates cells 118 with geographic regions. In one implementation, the interference prediction engine 720 computes the beam coverage areas in a same coordinate system used to geographically define the cell coverage areas. In other implementations, the interference prediction engine 720 maps the computed beam coverage areas and/or the cell coverage areas into a common coordinate system. The interference prediction engine 720 generates a set of interference conditions 725 for each particular time, such that the interference conditions 725 indicate each instance in which a cell 118 is determined to be geographically overlapping with a beam 108.

In some cases, all beams 108 of the NTN infrastructure communicate in an NTN spectrum band that overlaps with spectrum used by cells 118 of the TN infrastructure. In such cases, all cases of overlap are treated as interference conditions 725. In other cases, only some beams 108 of the NTN infrastructure communicate in a frequency band that overlaps with spectrum used by cells 118 of the TN infrastructure. In some implementations for such cases, only the subset of beams 108 communicating over overlapping spectrum are considered in the above determination of interference conditions 725. For example, such implementations may only compute beam coverage areas for the subset of beams 108, and/or such implementations may only determine whether there is overlap involving the subset of beams 108. In other implementations for such cases, interference conditions 725 are computed for all beams 108 initially as candidate interference conditions 725. The candidate interference conditions 725 are then filtered into a final list of interference conditions 725 by removing any of the candidate interference conditions 725 in which there is no spectrum overlap.

Each interference condition 725 represents a condition in which there is some cell 118 for which, at some particular time, there is a beam 108 that occupies an overlapping geographical coverage area and communicates over an overlapping frequency band, thereby potentially causing co-channel interference. As such, for each interference condition 725, there is an implicated cell 118 and an implicated beam 108 for the associated temporal frame. In some cases, each interference condition 725 is associated with additional information that may be relevant to one or more types of scheduled orthogonalization described herein. For example, the interference condition may be associated with an implicated sub-band (i.e., the portion of the cell's 118 TN spectrum overlapping with the beam's 108 frequency band), which may inform parameters of a spectral orthogonalization scheme as applied to address that interference condition 725.

The orthogonalizing engine 730 is configured to schedule orthogonalization schemes to address each of the interference conditions 725. For each interference condition 725, the orthogonalizing engine 730 can determine an appropriate orthogonalization approach (e.g., temporal, spectral, or code-based). In some cases, the same orthogonalization approach is used for all interference conditions 725. For example, the orthogonalization approach is determined based on characteristics of the network deployments, such as the amount of coordination between the TN and NTN portions of the network. In other cases, different orthogonalization approaches are selected for different ones of the interference conditions 725. For each interference condition 725, consistent with the chosen orthogonalization approach, a first orthogonalization scheme is scheduled for application to the implicated cell during the associated temporal frame, and a second orthogonalization scheme is scheduled for application to the implicated beam during the associated temporal frame, so that the first and second orthogonalization schemes are orthogonal (or partially orthogonal in the case of partial spectral orthogonalization, as in FIG. 3).

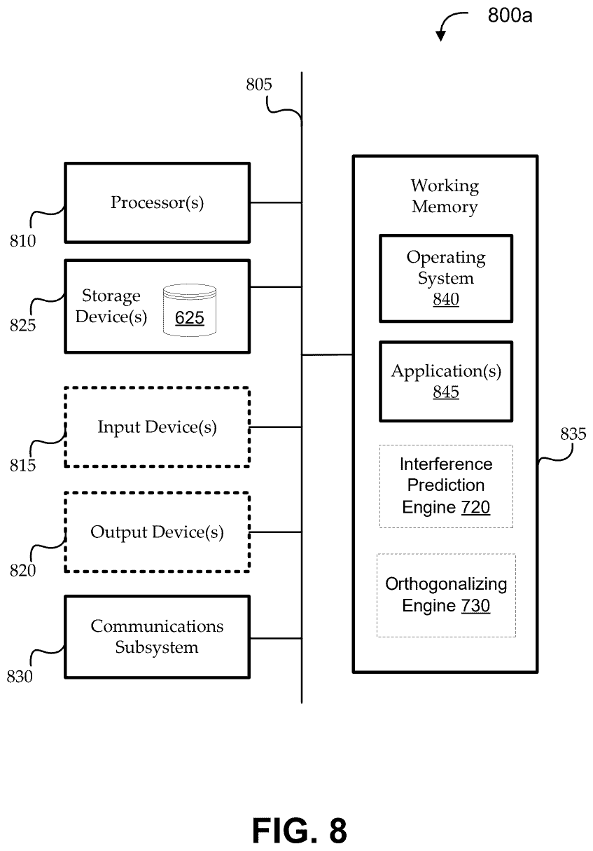

In some embodiments, components of the TN-NTN Interference Manager 710 can be implemented in a computational environment. FIG. 8 provides a schematic illustration of an embodiment of a computational system 800 that can implement various system components and/or perform various steps of methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computational system 800 is shown including hardware elements that can be electrically coupled via a bus 805 (or may otherwise be in communication, as appropriate). The hardware elements may include one or more processors 810, including, without limitation, one or more general-purpose processors and/or one or more special-purpose processors (such as digital signal processing chips, graphics acceleration processors, video decoders, and/or the like). Optionally, embodiments of the computational system 800 can include one or more input devices 815, and/or one or more output devices 820. The input devices 815 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 820 can include user output devices (e.g., display devices, printers, and/or the like), and/or machine input devices (e.g., computer-to-computer interfaces, such as wired and/or wireless output data ports).

The computational system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 825 include memory for storing ephemeris data 712, beam data 714, cell data 716, interference conditions 725, and/or other information used by embodiments to implement features described herein. For example, the storage devices 825 can include database(s) 625.

The computational system 800 can also include a communications subsystem 830, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 800 is deployed, the communications subsystem 830 can include any suitable hardware and/or software components for communicating with other salient portions of the network.

The computational system 800 further includes a working memory 835, which can include a RAM or ROM device, as described herein. The computational system 800 also can include software elements, shown as currently being located within the working memory 835, including an operating system 840, device drivers, executable libraries, and/or other code, such as one or more application programs 845, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 840 and the working memory 835 can be used in conjunction with the one or more processors 810 to implement the some or all of the interference prediction engine 720 and/or the orthogonalizing engine 730.

A set of these instructions and/or codes can be stored on a non-transitory (or non-transient) computer-readable storage medium, such as the non-transitory storage device(s) 825 described above. In some cases, the storage medium can be incorporated within a computer system, such as computational system 800. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 800 and/or can take the form of source and/or installable code, which, upon compilation and/or installation on the computational system 800 (e.g., using any of a variety of generally available compilers, installation programs, compression/decompression utilities, etc.), then takes the form of executable code.

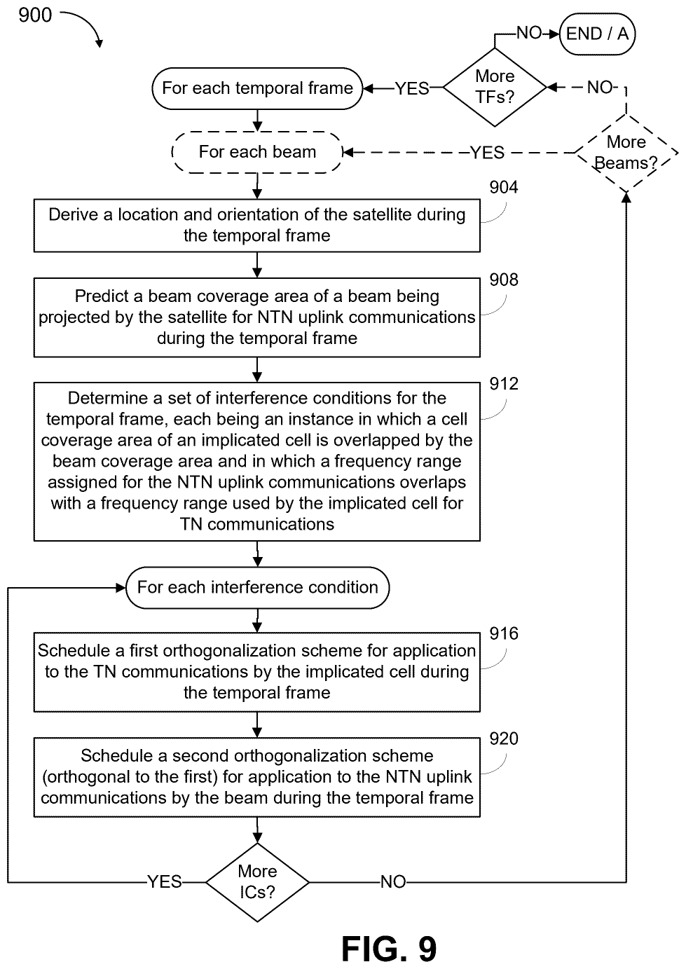

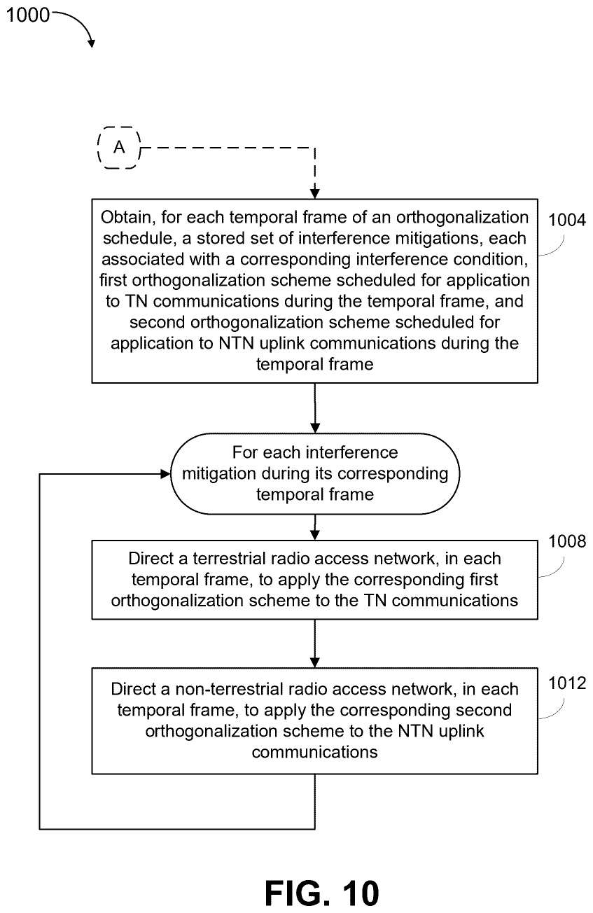

In some embodiments, the computational system 800 implements a portion of a system for communicating a data signal in a wireless communication network, as described herein. In some embodiments, the non-transitory storage device(s) 825 can have instructions stored thereon, which, when executed, cause the processor(s) 810 to perform steps of the method 900 of FIG. 9. In other embodiments, the non-transitory storage device(s) 825 can have instructions stored thereon, which, when executed, cause the processor(s) 810 to perform steps of the method 1000 of FIG. 10.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 800) to perform methods in accordance with various embodiments of the invention. According to a set of embodiments, some or all of the procedures of such methods are performed by the computational system 800 in response to processor 810 executing one or more sequences of one or more instructions (which can be incorporated into the operating system 840 and/or other code, such as an application program 845) contained in the working memory 835. Such instructions may be read into the working memory 835 from another computer-readable medium, such as one or more of the non-transitory storage device(s) 825. Merely by way of example, execution of the sequences of instructions contained in the working memory 835 can cause the processor(s) 810 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 800, various computer-readable media can be involved in providing instructions/code to processor(s) 810 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 825. Volatile media include, without limitation, dynamic memory, such as the working memory 835. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a disk of a remote computer. The remote computer can load the instructions into its dynamic memory and send the instructions as signals over a transmission medium to be received and/or executed by the computational system 800. The communications subsystem 830 (and/or components thereof) generally will receive signals, and the bus 805 then can carry the signals (and/or the data, instructions, etc., carried by the signals) to the working memory 835, from which the processor(s) 810 retrieves and executes the instructions. The instructions received by the working memory 835 may optionally be stored on a non-transitory storage device 825 either before or after execution by the processor(s) 810.

FIG. 9 shows a flow diagram of an illustrative method 900 for terrestrial network (TN) uplink and downlink co-channel interference mitigation on non-terrestrial network (NTN) uplinks, according to embodiments described herein. As illustrated, embodiments iterate for all temporal frames of an orthogonalization schedule. The orthogonalization schedule can be predefined for any suitable amount of time, depending on predictability over time and/or the desire for adaptability. In some embodiments, the scheduled orthogonalization approaches described herein are used only to address static and predictable interference conditions, such as based on ephemeris data, pre-planned beam data, pre-planned cell data, etc. In such cases, the orthogonalization schedule can be predefined and statically applied for the TN-NTN deployment. For example, a TN provider and an NTN provider agree as part of the deployment to the orthogonalization schedule in advance of and/or along with deployment of the networks. In other embodiments, the orthogonalization schedule is defined for a period of time, such as for 24 hours, 48 hours, etc. In such cases, a new orthogonalization schedule is deployed periodically in accordance with the defined period of time. In some embodiments, the orthogonalization schedule is predefined either for the planned life of the deployment, or for some period of time, and the orthogonalization schedule also permits some dynamic adaptation to changing conditions. In any of the above embodiments, the orthogonalization schedule can be segmented into any suitable number of temporal frames to provide any desired temporal resolution to changes in orthogonalization.

Some embodiments also iterate for each beam of the NTN. For example, the NTN can include a constellation of satellites. For example, the NTN can include several satellites, hundreds of satellites, etc. Also, each satellite can produce several beams. For example, a satellite can produce a multi-color (e.g., 4-color) beam pattern. As illustrated, the method 900 can iterate through all the beams for each temporal frame. Alternatively, the method 900 can iterate through all temporal frames for each beam. Although not shown, embodiments can alternatively or additionally iterate for each cell of the TN. For example, for each temporal frame, the method 900 can evaluate each cell coverage area to look for beam overlaps and/or look at each beam coverage area for cell overlaps.

Each iteration of the method 900 (i.e., at least for each temporal frame) can begin at stage 904 by deriving a location and orientation of the satellite during the temporal frame. The location and orientation can be derived from stored ephemeris data for the NTN. At stage 908, embodiments can predict a beam coverage area of a beam being projected by the satellite for NTN uplink communications during the temporal frame. The prediction at stage 908 can be based on stored beam data for the NTN and the derived location and orientation from stage 904.

At stage 912, embodiments can determine a set of interference conditions for the temporal frame. Each interference condition corresponds to an instance in which a cell coverage area of an implicated cell (of the large number of cells of the TN) is overlapped by the beam coverage area and in which an implicated frequency range is assigned for both the NTN uplink communications in the beam and TN communications in the implicated cell during the temporal frame. In some cases, the TN communications are TN uplink communications. In some cases, the TN communications are TN downlink communications. In some cases, the TN communications are both TN uplink and downlink communications.

Having determined the set of interference conditions in stage 912, embodiments can iterate stages 916 and 920 for each of the determined interference conditions for the temporal frame. For example, it may be likely that in any particular temporal frame, multiple interference conditions will simultaneously be of concern. For each of the determined interference conditions, at stage 916, embodiments can schedule a first orthogonalization scheme for application to the TN communications by the implicated cell during the temporal frame. For each of the determined interference conditions, at stage 920, embodiments can also schedule a second orthogonalization scheme for application to the NTN uplink communications by the beam during the temporal frame. As described herein, the first and second orthogonalization schemes are orthogonal in time, frequency, and/or code.

In some embodiments, the scheduling in stages 916 and 920 includes segmenting the temporal frame into time slots, scheduling a first subset of the time slots as the first orthogonalization scheme for the TN communications by the implicated cell during the temporal frame, and scheduling a second subset of the time slots as the second orthogonalization scheme for the NTN uplink communications by the beam during the temporal frame, wherein the first and second subsets of the time slots are temporally orthogonal. In some such embodiments, the scheduling further includes computing a temporal confidence based on an amount of coordination between a terrestrial radio access network (T-RAN) directing the TN communications and a non-terrestrial radio access network (NT-RAN) directing the NTN communications. Such embodiments can include scheduling a third subset of the time slots as one or more padding times based on the temporal confidence. At least a portion of the third subset is temporally orthogonal to the first and second subsets. For example, in cases where there is less coordination between the T-RAN and NT-RAN, a larger portion of the time slots is allocated as padding times. In cases where there is very tight coordination between the T-RAN and the NT-RAN, there may be no time slots allocated as padding times.

In some embodiments, the scheduling in stages 916 and 920 includes segmenting the temporal frame into bandwidth parts, scheduling a first subset of the bandwidth parts as the first orthogonalization scheme for the TN communications by the implicated cell during the temporal frame, and scheduling a second subset of the bandwidth parts as the second orthogonalization scheme for the NTN uplink communications by the beam during the temporal frame. The first and second subsets of the bandwidth parts are spectrally orthogonal. As described herein, some embodiments (e.g., as in FIG. 3) allow for partial temporal orthogonality. Other embodiments (e.g. as in FIG. 4) provide complete temporal orthogonality.

Some embodiments account for communication resource demand, such as demand for bandwidth. In such embodiments, the scheduling in stages 916 and 920 includes determining a communication resource demand for the temporal frame indicating a demand for TN communication resources and/or for NTN uplink communication resources. For example, TN and/or NTN resource demands for a particular temporal frame can be predicted based on respective geographic locations of cells and beams at that temporal frame, based on time of day at those locations, based on numbers of users in those locations, etc. Embodiments that apply temporal orthogonalization can further determine respective numbers of the time slots to allocate as each of the first and second subsets based on the communication resource demand. Embodiments that apply spectral orthogonalization can further determining respective numbers of the plurality of bandwidth parts to allocate as each of the first and second subsets based on the communication resource demand.

In some embodiments, the scheduling in stages 916 and 920 includes determining a first cover code and a second cover code, such that the first cover code and the second cover code are code-wise orthogonal. As described herein, the first and second cover codes (C1 and C2) are considered code-wise orthogonal when C1*C2=0, and C1*C1=C2*C2=1. Such embodiments further include scheduling multiplication of the TN communications by the first cover code prior to transmitting the TN communications during the temporal frame as the first orthogonalization scheme, and scheduling multiplication of the NTN uplink communications by the second cover code prior to transmitting the NTN communications during the temporal frame as the second orthogonalization scheme. As described with reference to FIG. 5, the result of the multiplication is coded TN and NTN signals, which combine, along with TN channel gains, to form the NTN signals received by the satellite payload. Multiplying the received NTN signals again by the second cover code can effectively cancel out the co-channel interference and leave the NTN uplink portion of the signal intact.

FIG. 10 shows a flow diagram of another illustrative method 1000 for terrestrial network (TN) uplink and downlink co-channel interference mitigation on non-terrestrial network (NTN) uplinks, according to embodiments described herein. For example, FIG. 9 describes a method 900 for planning and defining the orthogonalization schedule, and FIG. 10 describes a method 1000 for implementing the orthogonalization schedule. As such, FIG. 10 can, in some cases, be considered as an extension of FIG. 9.

Embodiments of the method 1000 begin at stage 1004 by obtaining a stored set of interference mitigations for each of some or all of the temporal frames of an orthogonalization schedule. For example, as described with reference to the orthogonalization schedule defined in FIG. 9, each interference mitigation is associated with a corresponding one of a set of interference conditions for the temporal frame, with a corresponding first orthogonalization scheme scheduled for application to TN communications by an implicated cell during the temporal frame, and with a corresponding second orthogonalization scheme scheduled for application to NTN uplink communications during the temporal frame. As described herein, the first and second orthogonalization schemes are orthogonal with respect to time, frequency, and/or code. Each of the set of interference conditions is previously determined (e.g., according to method 900) by predicting a beam coverage area of a beam being projected by the satellite for NTN uplink communications during the temporal frame, such that each of the set of interference conditions corresponds to an instance in which a cell coverage area of an implicated cell of a plurality of cells of the TN is overlapped by the beam coverage area and in which an implicated frequency range is assigned for both the NTN uplink communications in the beam and TN communications in the implicated cell during the temporal frame.

Having obtained the interference mitigations for each temporal frame, the method 1000 can implement those interference mitigations at their appropriate times in accordance with their corresponding interference condition, first orthogonalization scheme, and second orthogonalization scheme. Thus, the method 1000 can iterate stages 1008 and 1012 for each interference mitigation in each temporal frame. At stage 1008 (for each interference mitigation for each temporal frame), embodiments can direct a terrestrial radio access network to apply the corresponding first orthogonalization scheme to the TN communications by the implicated cell. At stage 1012 (for each interference mitigation for each temporal frame), embodiments can direct a non-terrestrial radio access network to apply the corresponding second orthogonalization scheme to the NTN uplink communications.

In some embodiments, each temporal frame is segmented into a plurality of time slots. In such embodiments, for each of the stored set of interference mitigations during its corresponding temporal frame of the plurality of temporal frames, the first orthogonalization scheme can define a first subset of the time slots to use for the TN communications (during the temporal frame), and the second orthogonalization scheme can define a second subset of the time slots to use for the NTN uplink communications (during the temporal frame). As described herein, the first and second subsets of the time slots are temporally orthogonal. Further, such embodiments, for each of the stored set of interference mitigations during its corresponding temporal frame of the plurality of temporal frames, can direct the terrestrial radio access network to allocate the first subset of the time slots for the TN communications (during the temporal frame), and can direct the non-terrestrial radio access network the allocate the second subset of the time slots for the NTN uplink communications (during the temporal frame). Some such embodiments, for each of the stored set of interference mitigations during its corresponding temporal frame of the plurality of temporal frames, further include directing the terrestrial radio access network and/or the non-terrestrial radio access network to allocate a third subset of the time slots of the temporal frame for one or more padding times based on a temporal confidence. At least a portion of the third subset is temporally orthogonal (i.e., non-overlapping in time) to the first and second subsets, and the temporal confidence is computed based on an amount of coordination between the terrestrial radio access network and the non-terrestrial radio access network.

In some embodiments, each temporal frame is segmented into a plurality of bandwidth parts. In such embodiments, for each of the stored set of interference mitigations during its corresponding temporal frame of the plurality of temporal frames, the first orthogonalization scheme can define a first subset of the bandwidth parts to use for the TN communications (during the temporal frame), and the second orthogonalization scheme can define a second subset of the bandwidth parts to use for the NTN uplink communications (during the temporal frame). As described herein, the first and second subsets of the bandwidth parts are spectrally orthogonal. Further, such embodiments, for each of the stored set of interference mitigations during its corresponding temporal frame of the plurality of temporal frames, can direct the terrestrial radio access network to allocate the first subset of the bandwidth parts for the TN communications (during the temporal frame), and can direct the non-terrestrial radio access network the allocate the second subset of the bandwidth parts for the NTN uplink communications (during the temporal frame).

Some embodiments further predict a communication resource demand for each temporal frame (and/or for each interference mitigation) indicating a demand for TN communication resources and/or for NTN uplink communication resources. Embodiments applying scheduled temporal orthogonalization can determine respective numbers of the time slots to allocate as each of the first and second subsets based on the communication resource demand. Embodiments applying scheduled spectral orthogonalization can determine respective numbers of the bandwidth parts to allocate as each of the first and second subsets based on the communication resource demand.

In some embodiments, for each of the stored set of interference mitigations during its corresponding temporal frame of the plurality of temporal frames, the first orthogonalization scheme defines a first cover code, and the second orthogonalization scheme defines a second cover code. The first cover code and the second cover code are code-wise orthogonal. In some embodiments, the same first and second cover codes are used in all applications of scheduled code-wise orthogonalization. In other embodiments, different first and second cover codes are used in some or all applications (e.g., in some or all temporal frames) of scheduled code-wise orthogonalization. Such embodiments, for each of the stored set of interference mitigations during its corresponding temporal frame of the plurality of temporal frames, can direct the terrestrial radio access network to multiply the TN communications by the first cover code prior to transmitting the TN communications during the temporal frame and can direct the non-terrestrial radio access network to multiply the NTN uplink communications by the second cover code prior to transmitting the NTN uplink communications during the temporal frame. Some such embodiments also direct a payload of the satellite to multiply the second cover code by NTN uplink signals received by the payload in the temporal frame. As described herein, the NTN uplink signals as received by the payload comprise a sum of: the TN communications multiplied by the first cover code and by one or more channel gains; and the NTN communications multiplied by the second cover code.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for mitigating terrestrial network (TN) co-channel interference on a non-terrestrial network (NTN) uplink associated with a satellite of the NTN, the method comprising:
for each of a plurality of temporal frames of an orthogonalization schedule:
deriving a location and orientation of the satellite during the temporal frame from stored ephemeris data for the NTN;
predicting a beam coverage area of a beam being projected by the satellite for NTN uplink communications during the temporal frame based on stored beam data for the NTN and the derived location and orientation;
determining a set of interference conditions for the temporal frame, such that each interference condition corresponds to an instance in which a cell coverage area of an implicated cell of a plurality of cells of the TN is overlapped by the beam coverage area and in which an implicated frequency range is assigned for both the NTN uplink communications in the beam and TN communications in the implicated cell during the temporal frame; and
scheduling, for each of the set of interference conditions, a first orthogonalization scheme for application to the TN communications by the implicated cell during the temporal frame, and a second orthogonalization scheme for application to the NTN uplink communications by the beam during the temporal frame, wherein the first and second orthogonalization schemes are orthogonal.

2. The method of claim 1, wherein the scheduling comprises:
segmenting the temporal frame into a plurality of time slots;
scheduling a first subset of the time slots as the first orthogonalization scheme for the TN communications by the implicated cell during the temporal frame; and
scheduling a second subset of the time slots as the second orthogonalization scheme for the NTN uplink communications by the beam during the temporal frame, wherein the first and second subsets of the time slots are temporally orthogonal.

3. The method of claim 2, wherein the scheduling further comprises:
computing a temporal confidence based on an amount of coordination between a terrestrial radio access network (T-RAN) directing the TN communications and a non-terrestrial radio access network (NT-RAN) directing the NTN communications; and
scheduling a third subset of the time slots as one or more padding times based on the temporal confidence, wherein at least a portion of the third subset is temporally orthogonal to the first and second subsets.

4. The method of claim 2, wherein the scheduling further comprises:
determining a communication resource demand for the temporal frame indicating a demand for TN communication resources and/or for NTN uplink communication resources, and
determining respective numbers of the plurality of time slots to allocate as each of the first and second subsets based on the communication resource demand.

5. The method of claim 1, wherein the scheduling comprises:
segmenting the implicated frequency range into a plurality of bandwidth parts;
scheduling a first subset of the bandwidth parts as the first orthogonalization scheme for the TN communications by the implicated cell during the temporal frame; and
scheduling a second subset of the bandwidth parts as the second orthogonalization scheme for the NTN uplink communications by the beam during the temporal frame, wherein the first and second subsets of the bandwidth parts are spectrally orthogonal.

6. The method of claim 5, wherein the scheduling further comprises:
determining a communication resource demand for the temporal frame indicating a demand for TN communication resources and/or for NTN uplink communication resources, and
determining respective numbers of the plurality of bandwidth parts to allocate as each of the first and second subsets based on the communication resource demand.

7. The method of claim 1, wherein the scheduling comprises:
determining a first cover code and a second cover code, such that the first cover code and the second cover code are code-wise orthogonal;
scheduling multiplication of the TN communications by the first cover code prior to transmitting the TN communications during the temporal frame as the first orthogonalization scheme; and
scheduling multiplication of the NTN uplink communications by the second cover code prior to transmitting the NTN communications during the temporal frame as the second orthogonalization scheme.

8. A method for mitigating terrestrial network (TN) co-channel interference on a non-terrestrial network (NTN) uplink associated with a satellite of the NTN, the method comprising:
obtaining, for each of a plurality of temporal frames of an orthogonalization schedule, a stored set of interference mitigations for the temporal frame, wherein:
each interference mitigation is associated with a corresponding one of a set of interference conditions for the temporal frame, with a corresponding first orthogonalization scheme scheduled for application to TN communications by an implicated cell during the temporal frame, and with a corresponding second orthogonalization scheme scheduled for application to NTN uplink communications during the temporal frame,
the first and second orthogonalization schemes are orthogonal, and
each of the set of interference conditions is previously determined by predicting a beam coverage area of a beam being projected by the satellite for NTN uplink communications during the temporal frame, such that each of the set of interference conditions corresponds to an instance in which a cell coverage area of an implicated cell of a plurality of cells of the TN is overlapped by the beam coverage area and in which an implicated frequency range is assigned for both the NTN uplink communications in the beam and TN communications in the implicated cell during the temporal frame;
directing a terrestrial radio access network, for each of the stored set of interference mitigations during its corresponding temporal frame of the plurality of temporal frames, to apply the corresponding first orthogonalization scheme to the TN communications by the implicated cell; and
directing a non-terrestrial radio access network, for each of the stored set of interference mitigations during its corresponding temporal frame of the plurality of temporal frames, to apply the corresponding second orthogonalization scheme to the NTN uplink communications.

9. The method of claim 8, wherein:
each temporal frame is segmented into a plurality of time slots; and
for each of the stored set of interference mitigations during its corresponding temporal frame of the plurality of temporal frames:
the first orthogonalization scheme defines a first subset of the time slots to use for the TN communications;
the second orthogonalization scheme defines a second subset of the time slots to use for the NTN uplink communications, wherein the first and second subsets of the time slots are temporally orthogonal;
the directing the terrestrial radio access network comprises allocating the first subset of the time slots for the TN communications; and
the directing the non-terrestrial radio access network comprises allocating the second subset of the time slots for the NTN uplink communications.

10. The method of claim 9, further comprising:
directing the terrestrial radio access network and/or the non-terrestrial radio access network, for each of the stored set of interference mitigations during its corresponding temporal frame of the plurality of temporal frames, to allocate a third subset of the time slots of the temporal frame for one or more padding times based on a temporal confidence,
wherein at least a portion of the third subset is temporally orthogonal to the first and second subsets, and
wherein the temporal confidence is computed based on an amount of coordination between the terrestrial radio access network and the non-terrestrial radio access network.

11. The method of claim 9, further comprising:
predicting a communication resource demand for the temporal frame indicating a demand for TN communication resources and/or for NTN uplink communication resources; and
determining respective numbers of the plurality of time slots to allocate as each of the first and second subsets based on the communication resource demand.

12. The method of claim 8, wherein:
each temporal frame is segmented into a plurality of bandwidth parts; and
for each of the stored set of interference mitigations during its corresponding temporal frame of the plurality of temporal frames:
the first orthogonalization scheme defines a first subset of the bandwidth parts to use for the TN communications;
the second orthogonalization scheme defines a second subset of the bandwidth parts to use for the NTN uplink communications, wherein the first and second subsets of the bandwidth parts are spectrally orthogonal;
the directing the terrestrial radio access network comprises allocating the first subset of the bandwidth parts for the TN communications; and
the directing the non-terrestrial radio access network comprises allocating the second subset of the bandwidth parts for the NTN uplink communications.

13. The method of claim 12, further comprising:
predicting a communication resource demand for the temporal frame indicating a demand for TN communication resources and/or for NTN uplink communication resources; and
determining respective numbers of the plurality of bandwidth parts to allocate as each of the first and second subsets based on the communication resource demand.

14. The method of claim 8, wherein, for each temporal frame:
the first orthogonalization scheme defines a first cover code;
the second orthogonalization scheme defines a second cover code, wherein the first cover code and the second cover code are code-wise orthogonal; and
for each of the stored set of interference mitigations during its corresponding temporal frame of the plurality of temporal frames:
the directing the terrestrial radio access network comprises multiplying the TN communications by the first cover code prior to transmitting the TN communications; and
the directing the non-terrestrial radio access network comprises multiplying the NTN uplink communications by the second cover code prior to transmitting the NTN uplink communications.

15. The method of claim 14, further comprising, for each of the stored set of interference mitigations during its corresponding temporal frame of the plurality of temporal frames:
directing a payload of the satellite to multiply the second cover code by NTN uplink signals received by the payload,
wherein the NTN uplink signals as received by the payload comprise a sum of: the TN communications multiplied by the first cover code and by one or more channel gains; and the NTN communications multiplied by the second cover code.

16. A system for mitigating terrestrial network (TN) co-channel interference on a non-terrestrial network (NTN) uplink associated with a satellite of the NTN, the system comprising:
one or more processors; and
a non-transitory, computer-readable memory having instructions stored thereon, which, when executed, cause the one or more processors to perform steps comprising:
obtaining, for each of a plurality of temporal frames of an orthogonalization schedule, a stored set of interference mitigations for the temporal frame, wherein each of the set of interference conditions is:
associated with a corresponding one of a set of interference conditions for the temporal frame, with a corresponding first orthogonalization scheme scheduled for application to TN communications by an implicated cell during the temporal frame, and with a corresponding second orthogonalization scheme scheduled for application to NTN uplink communications during the temporal frame, the first and second orthogonalization schemes being orthogonal; and
previously determined by predicting a beam coverage area of a beam being projected by the satellite for NTN uplink communications during the temporal frame, such that each of the set of interference conditions corresponds to an instance in which a cell coverage area of an implicated cell of a plurality of cells of the TN is overlapped by the beam coverage area and in which an implicated frequency range is assigned for both the NTN uplink communications in the beam and TN communications in the implicated cell during the temporal frame;
directing a terrestrial radio access network, for each of the stored set of interference mitigations during its corresponding temporal frame of the plurality of temporal frames, to apply the corresponding first orthogonalization scheme to the TN communications by the implicated cell; and
directing a non-terrestrial radio access network, for each of the stored set of interference mitigations during its corresponding temporal frame of the plurality of temporal frames, to apply the corresponding second orthogonalization scheme to the NTN uplink communications.

17. The system of claim 16, wherein:
each temporal frame is segmented into a plurality of time slots; and
for each of the stored set of interference mitigations during its corresponding temporal frame of the plurality of temporal frames:
the first orthogonalization scheme defines a first subset of the time slots to use for the TN communications;
the second orthogonalization scheme defines a second subset of the time slots to use for the NTN uplink communications, wherein the first and second subsets of the time slots are temporally orthogonal;
the directing the terrestrial radio access network comprises allocating the first subset of the time slots for the TN communications; and
the directing the non-terrestrial radio access network comprises allocating the second subset of the time slots for the NTN uplink communications.

18. The system of claim 16, wherein:
each temporal frame is segmented into a plurality of bandwidth parts; and
for each of the stored set of interference mitigations during its corresponding temporal frame of the plurality of temporal frames:
the first orthogonalization scheme defines a first subset of the bandwidth parts to use for the TN communications;
the second orthogonalization scheme defines a second subset of the bandwidth parts to use for the NTN uplink communications, wherein the first and second subsets of the bandwidth parts are spectrally orthogonal;
the directing the terrestrial radio access network comprises allocating the first subset of the bandwidth parts for the TN communications; and
the directing the non-terrestrial radio access network comprises allocating the second subset of the bandwidth parts for the NTN uplink communications.

19. The system of claim 16, wherein:
the first orthogonalization scheme defines a first cover code;
the second orthogonalization scheme defines a second cover code, wherein the first cover code and the second cover code are code-wise orthogonal; and
for each of the stored set of interference mitigations during its corresponding temporal frame of the plurality of temporal frames:
the directing the terrestrial radio access network comprises multiplying the TN communications by the first cover code prior to transmitting the TN communications; and
the directing the non-terrestrial radio access network comprises multiplying the NTN uplink communications by the second cover code prior to transmitting the NTN uplink communications.

20. The system of claim 16, wherein:
the non-transitory memory is disposed in a centralized network resource that is accessible to both the terrestrial radio access network and the non-terrestrial radio access network.
